(19) United States
(12) Patent Application Publication
(10) Pub. No.: US 2005/0038181 A1
(43) Pub. Date: Feb. 17, 2005

(54) Silicone polymer based liquid tooth whitening composition

(75) Inventors: Suman K. Chopra, Dayton, NJ (US); Lynette A. Zaidel, Cranford, NJ (US); Guisheng Pan, Spots Wood, NJ (US); Suryakant Patel, Bridgewater, NJ (US); Ryan B. Cameron, Somerset, NJ (US); Michael Prencipe, West Windsor, NJ (US)

Correspondence Address: COLGATE-PALMOLIVE COMPANY, 909 RIVER ROAD, PISCATAWAY, NJ, 08855, US

(73) Assignee: Colgate-Palmolive Company

(21) Appl. No.: 10/642,458

(22) Filed: Aug. 15, 2003

(51) Int. Cl. C08L 83/00

(52) U.S. Cl. 524/588

(57) ABSTRACT

A stable, nonaqueous liquid tooth whitening composition comprised of an anhydrous peroxide compound dispersed in an orally acceptable hydrophobic organic material such as a silicone based pressure sensitive polymer which composition when applied topically to tooth surfaces forms an adherent layer containing the peroxide compound which peroxide compound is thereafter is released from the layer to effect tooth whitening.

### BACKGROUND OF THE INVENTION

1. Field of the Invention

This invention relates to a stable liquid tooth whitening composition.

2. The Prior Art

It has become desirable for a person's teeth to appear bright or “white”. Society places a high value on the “whiteness” of one's teeth. One whose teeth are white may enjoy more personal confidence and satisfaction and may even enjoy greater social acceptance.

A tooth is comprised of an inner dentin layer and an outer hard enamel layer that is the protective layer of the tooth. The enamel layer of a tooth is naturally an opaque white or slightly off-white color. It is the enamel layer that can become stained or discolored. The enamel layer of a tooth is composed of hydroxyapatite mineral crystals that create a somewhat porous surface. These hydroxyapatite crystals form microscopic hexagonal rods or prisms that make up the enamel surface. As a result, the surface of the enamel layer presents microscopic spaces or pores between the prisms. It is believed that this porous nature of the enamel layer is what allows staining agents and discoloring substances to permeate the enamel and discolor the tooth. These remaining substances can occupy the microscopic spaces and eventually alter the color of the tooth.

Many substances that a person confronts or comes in contact with on a daily basis can “stain” or reduce the “whiteness” of one's teeth. In particular, the foods, tobacco products and fluids that one consumes tend to stain one's teeth. These products or substances tend to accumulate on the enamel layer of the tooth and form a pellicle film over the teeth. These staining and discoloring substances can then permeate the enamel layer. This problem occurs gradually over many years, but imparts a noticeable discoloration of the enamel of one's teeth. So long as the discolored teeth are still healthy and do not pose any health risk or problem, a product or substance that would whiten the discolored teeth would be advantageous.

It is also essential that a tooth whitening product that is to be used at home or in private by the consumer be safe and easy to use and be stable and retain its whitening efficacy during its storage on retail store shelves as well as over the period of use by the consumer.

Products and substances that are presently available to whiten teeth include a variety of different ingredients, but the primary active ingredient is a peroxide agent formulated into an aqueous liquid, solution, paste or gel. These products upon storage lose their whitening efficacy over time as peroxide compounds in aqueous solutions are relatively unstable. This tendency toward instability of peroxide has limited the utility of aqueous liquid whitening products for whitening teeth. It would be highly desirable, therefore, to provide a stable peroxide whitening liquid to effect substantive whitening.

### SUMMARY OF THE INVENTION

In accordance with one aspect of this invention there is provided a stable non-aqueous liquid dental whitening composition comprised of an peroxide releasing compound dispersed in an anhydrous hydrophobic silicone polymer based pressure sensitive adhesive, the composition when applied to the teeth being sufficiently viscous to form an adherent, continuous layer of the peroxide containing composition on dental enamel surfaces.

The anhydrous hydrophobic liquid silicone polymer based pressure sensitive adhesive of the present invention provides a stable vehicle that prevents the decomposition of the peroxide whitening agent during storage and before use. Once applied on tooth surface, the saliva on the tooth enamel surface to which the composition is applied will either dissolve or disintegrate the peroxide containing matrix resulting in a rapid decomposition of the peroxide, which in turn provides the whitening effect.

The liquid whitening composition of the present invention is a portable tooth whitener that can be applied to the teeth as a coated layer on a strip or conveniently painted onto the tooth enamel surface. Upon application to the teeth, the applied liquid whitening composition forms an adherent layer of peroxide containing product that has the capacity to release the peroxide whitening agent over an extended period of time, e.g., from about 5 to about 45 minutes. The applied layer adheres to the tooth surface whereby the released peroxide source then whitens the teeth to which the composition is applied.

### DESCRIPTION OF THE PREFERRED EMBODIMENTS

The term “hydrophobic” polymer or “water-insoluble” polymer as employed herein refers to an organic polymer which has a water solubility of less than about one gram per 100 grams of water at 25° C.

The composition of the present invention is a viscous suspension which maintains its consistency during storage enabling the product to be painted on the tooth surface with a soft applicator brush.

Silicone Based Pressure Sensitive Adhesive

In accordance with the practice of the present invention the pressure sensitive adhesive (PSA) compositions in which the peroxide is dispersed are well known in the art and many are commercially available. Generally, silicone based PSA's are produced by condensing a silicone resin and an organosiloxane such as a polydiorganosilioxane. The PSA is an elastomeric, tacky material, adhesion of which dental enamel surfaces can be varied by altering the ratio of silicone resin to polydiorganosiloxane in the copolymer molecule. For example PSAs available from the Dow-Corning Company under the brand name BIO-PSA is pressure sensitive adhesive specifically designed for pharmaceutical use and is permeable to many drug compounds and finds application for the transdermal application of these compounds. The BIO-PSA silicone polymers are the copolymer product of mixing a silanol terminated polydiorganosiloxane such as polydimethyl siloxane with a silanol-containing silicone resin whereby the silanol groups of the polydiorganosiloxane undergo a condensation reaction with the silanol groups of the silicone resin so that the polydiorganosiloxane is lightly crosslinked by the silicone resin (that is, the polydiorganosiloxane chains are bonded together through the resin molecules to give chain branching and entanglement and/or a small amount of network character) to form the silicone pressure sensitive adhesive. A catalyst, for example an alkaline material such as ammonia, ammonium hydroxide or ammonium carbonate can be mixed with the silanol-terminated polydiorganosiloxane and the silicone resin to promote this crosslinking reaction.

By copolymerizing the silicone resin with the silanol terminated polydiorganosiloxane, the self adhering property and the cohesive properties of a soft elastomer matrix characteristic of pressure sensitive polymers and distinguished from the hard, non-elastomeric properties of silicone resins.

Modifying the silicone resin to polydiorganosiloxane ratio of the pressure sensitive adhesive will modify the tackiness of the PSA. For example, the BIO PSA silicone adhesive sold by Dow-Corning is available in three silicone resin to silicone polymer ratios namely, 65/35 (low tack), 60/40 (medium tack), 55/45 (high tack) dissolved in either ethyl acetate solvent or dimethicone. The silicone based pressure sensitive adhesive is present in the liquid whitening compositions of the present invention at a concentration of about 1 to about 80% by weight and preferably about 15 to about 40% by weight.

Adhesion Enhancing Agents

Organic materials which may be included in the compositions of the present invention to enhance the adhesive properties silicone based pressure sensitive adhesive of the present invention include adhesion enhancing agents such as waxes such as bees wax, mineral oil, plastigel, (a blend of mineral oil and polyethylene), petrolatum, white petrolatum, versagel (blend of liquid paraffin, butene/ethylene/styrene hydrogenated copolymer) polyethylene waxes, polyisobutene, polyvinyl pyrrolidone/vinyl acetate copolymers. Also effective as adhesion enhancing agents are liquid hydrophilic polymers including polyethylene glycols, nonionic polymers of ethylene oxide having the general formula:
HOCH₂(CH₂OCH₂)ₙCH₂OH
wherein n represents the average number of oxyethylene groups. Polyethylene glycols available from Dow Chemical are designated y a number such as 200, 300, 400, 600, 2000 which represents the approximate average molecular weight of the polymer, as well as nonionic block copolymer of ethylene oxide and propylene oxide of the formula:
HO(CH₄O)ₐ(C₃H₆O)_{b}(C₂H₄O)_{c}H

The block copolymer is preferably chosen (with respect to a, b and c) such that the ethylene oxide constituent comprises from about 65 to about 75% by weight, of said copolymer molecule and the copolymer has an average molecular weight of from about 2,000 to about 15,000 with the copolymer being present in the liquid tooth whitening composition in such concentration that the composition is liquid at room temperatures (23° C.).

A particularly desirable block copolymer for use in the practice of the present invention is available commercially from BASF and designated Pluraflo L1220 which has an average molecular weight of about 9,800. The hydrophilic poly(ethylene oxide) block averages about 65% by weight of the polymer.

Typically, adhesion enhancing polymers employed in the compositions of the invention are present in an amount of from about 0.5 to 20% by weight. Preferably, the polymers are present in an amount of from about 2 to about 15% by weight.

Peroxide Releasing Compound

Peroxide releasing compounds useful in the practice of the present invention include peroxide containing compounds such as urea peroxide, sodium percarbonate, sodium perborate and PVP-H₂O₂ complexes (hereinafter “PVP-H₂O₂”). PVP-H₂O₂ both linear and cross linked complexes are known to the art and are disclosed in U.S. Pat. No. 3,376,110 and U.S. Pat. No. 3,480,557 and have been used in compositions for treating acne vulgaris (U.S. Pat. No. 5,122,370). PVP-H₂O₂ complexes are disclosed in U.S. Pat. No. 5,122,370. PVP-H₂O₂ is stable in an anhydrous environment. By exposure to aqueous environments, as in the oral cavity, the PVP-H₂O₂ dissociates into individual species (PVP polymer and H₂O₂). The PVP-H₂O₂ complex is generally comprised of about 80% by weight polyvinyl pyrrolidone and 20% by weight H₂O₂.

The peroxide releasing compound is present in the liquid whitening compositions of the present invention at a concentration of about 0.5 to about 50% by weight and preferably about 10 to about 40% by weight.

Flavor

The liquid whitening composition of the present invention may also contain a flavoring agent. Flavoring agents that are used in the practice of the present invention include essential oils as well as various flavoring aldehydes, esters, alcohols, and similar materials. Examples of the essential oils include oils of spearmint, peppermint, wintergreen, sassafras, clove, sage, eucalyptus, marjoram, cinnamon, lemon, lime, grapefruit, and orange. Also useful are such chemicals as menthol, carvone, and anethole. Of these, the most commonly employed are the oils of peppermint, spearmint and wintergreen. The flavoring agent is incorporated in the whitening liquid composition of the present invention at a concentration of about 0.0 to about 2% by weight and preferably about 0.1 to about 0.5% by weight.

Sweetening Agent

A sweetening material may also be employed as an alternative or complement to the flavoring material. Suitable sweetening agents are water soluble and include sodium saccharin, sodium cyclamate, xylitol, perillartien, D-tryptophan, aspartame, dihydrochalcones and the like, in concentrations of about 0.01 to about 1% by weight. Sodium saccharin is preferred.

The liquid whitening composition of the present invention is prepared in the form of a flowable viscous liquid dispersion containing the whitening agent and is applied as such to the users teeth as by painting the teeth with a soft applicator brush. Application by the user, leaves a coating of the thick liquid suspension on the teeth. Contact with saliva causes the slow release of H₂O₂ from the hydrophobic material matrix to the applied tooth site from the anhydrous whitening compound providing prolonged whitening treatment of the tooth sites.

The layer of liquid peroxide containing composition contains no ingredients imparting thereto an unacceptable taste or texture, rendering it unpleasant to the user and adheres strongly to tooth enamel. The composition is sufficiently viscous and adherent enough to remain on the teeth for a period of time, for example 5 to 45 minutes to effect a whitening result and will resist the forces commonly applied by the lips and tongue. While the layer of applied liquid whitening composition is in place, the user is to refrain from mastication. The whitening composition can be removed as and when required, at will, by an employment of standard oral hygiene procedures such as brushing or by rinsing with an alcoholic mouthwash. While in place the coating releases agents contained therein at a slow, relatively constant rate and in concentration sufficient effectively to effect stain removal from the teeth.

Other ingredients which are included in the liquid whitening composition comprise materials commonly used in the oral care formulations. These include: antimicrobial agents, e.g., Triclosan, chlorhexidine, copper-, zinc- and stannous salts such as zinc citrate, zinc sulphate, zinc glycinate, sodium zinc citrate and stannous pyrophosphate, sanguinarine extract, metronidazole, quaternary ammonium compounds, such as cetylpyridinium chloride; bisguanides, such as chlorhexidine digluconate, hexetidine, octenidine, alexidine; and halogenated bisphenolic compounds, such as 2,2′ methylenebis-(4-chloro-6-bromophenol); antiinflammatory agents such as ibuprofen, flurbiprofen, aspirin, indomethacine; anticaries agents such as sodium-, calcium-, magnesium- and stannous fluoride, aminefluorides, disodium monofluorophosphate and sodium trimetaphosphate; plaque buffers such as urea, calcium lactate, calcium glycerophosphate and strontium polyacrylates; vitamins such as Vitamin C; plant extracts; desensitizing agents, e.g., potassium citrate, potassium chloride, potassium tartrate, potassium bicarbonate, potassium oxalate, potassium nitrate and strontium salts; agents effective against dental calculus such as pyrophosphate salts including the mono, di, tri and tetra alkali metal and ammonium pyrophosphate and tripolyphosphate salts; biomolecules, e.g., bacteriocins, antibodies, enzymes such as papain, glucoamylase; opacifying agents, pigments, coloring agents and fluoride ion providing salts having anticaries efficacy such as sodium fluoride, potassium fluoride, a tin fluoride such as stannous fluoride.

Composition Preparation

The liquid whitening compositions of the present invention are prepared by adding and mixing the ingredients of the composition in a suitable vessel such as a stainless steel tank provided with a mixer. In the preparation of the liquid whitening composition, the ingredients are advantageously added to the mixer in the following order: liquid anhydrous silicone based pressure sensitive polymer, peroxide whitening agent, adhesion enhancing agent and any desired flavoring or sweetener. The ingredients are then mixed to form a homogeneous dispersion/solution.

The present invention is illustrated by the following examples but is not to be limited thereby.

### EXAMPLE I

A series of liquid whitening paint-on composition was prepared using the ingredients listed in Table I below.

TABLE I

| Composition | | |
|---|---|---|
| Ingredients | A | B |
| BIO PSA (medium/high tack)* | 30.0 | 30.0 |
| Plastigel | 44.2 | 44.0 |
| Sodium percarbonate | 25 | — |
| PVP H₂0₂ cx** | — | 25.0 |
| Saccharin | 0.8 | 0.50 |
| Flavor | — | 0.50 |
| PEG 400 | — | — |
| Polyisobutente | — | — |

*Dissolved in 60% by weight dimethicone
**cx = cross-linked

The whitening compositions A and B were prepared by mixing the sodium percarbonate or PVPH₂O with the plastigel followed by the pressure sensitive adhesive BIO PSA, saccharin, flavor, PEG 400 or polyisobutene.

The shelf stability of the liquid whitening composition of Table I was determined by packaging the composition in sealed polypropylene bottles and exposing the bottles to 120° F. The percent hydrogen peroxide recovered from the liquid whitening composition after a 4 week exposure to temperatures of 120° F. was determined using Iodometric Titration. The peroxide recovery results indicated that the nonaqueous liquid whitening compositions A and B all retained 96-100% of the original peroxide content, thereby enabling the compositions to be efficacious whitening compositions even after 4 weeks of storage at the elevated temperature of 120° F.

The whitening efficacy of the liquid compositions was determined using a duplicate pair of flow cells designed to accommodate a total of eight bovine enamel blocks (four in each cell). The bovine enamel blocks were obtained freshly stained using an established staining protocol (Indiana University, Indianapolis, Ind.). The initial L*, a* and b* values were matched as closely as possible prior to the experiment using a chromameter (Minolta CR-321) based on initial L*, a* and b* values (CIELAB). These initial values were typically L*=25.00, a*=3.00, and b*=5.00 to L*=35.00, a*=5.00, and b*=7.00. The L, a, b values were measured four times at slightly differing locations on the surface of the bovine enamel blocks.

To simulate the saliva of the human mouth, an artificial saliva buffer solution maintained at 37° C. was prepared which contained the salts usually present in saliva at levels typical to the levels found in human saliva.

The bovine enamel blocks were placed in the flow cells and the liquid compositions evenly applied using a brush, the amount of product applied being determined using the weight difference of the container. Flow over the teeth was 0.6 ml/min. for 30 min. Average initial and final chromometer readings were used to calculate ΔE according to ΔE=((L_{f}−Lᵢ)²+(b_{f}−bᵢ)²+(a_{f}−aᵢ)²)^{1/2}. The final ΔE reported was the average over all observations after the rejection of outliers using the Student's test (95% confidence level). The results are recorded in Table II below. For purposes of comparison, the whitening efficacy test procedure of Example I was repeated with the exception that a commercially available paint-on tooth whitening composition designated composition X containing 6.75% by weight hydrogen peroxide was also evaluated for whitening efficacy. The results of these evaluation tests are recorded in Table II below.

TABLE II
Whitening Efficacy

| Composition | ΔE |
|---|---|
| A | 17 |
| B | 8.8* |
| X | 8.0 |
| X | 3.6* |

*Extrinsic stain removed from bovine teeth prior to test treatment. ΔE value represents intrinsic stain removal.

The results recorded in Table II indicate that the whitening efficacy (AE) of the compositions of the present invention (Compositions A and B) are substantially more efficacious than the comparative commercially available liquid tooth whitening compositions X.

### EXAMPLE II

A second series of silicone polymer based pressure sensitive whitening compositions was prepared, the ingredients of which are listed in Table III below.

TABLE III

| Composition | | |
|---|---|---|
| Ingredient | F | G |
| Ethyl acetate | 13.50 | 13.50 |
| Bio PSA (medium/high tack) | 35.00 | 35.0 |
| Pluracare L1220 | 5.00 | 5.0 |
| Sodium saccharin | 1.00 | 1.0 |
| Snow white petrolatum | 5.00 | 12.0 |
| Zinc oxide | 7.00 | — |
| Sodium percarbonate | 33.00 | 33.0 |
| Flavor | 0.50 | 0.50 |
| Total | 100.00 | 100.00 |

1. A stable tooth whitening composition suitable for application to teeth in the oral cavity comprising a peroxide releasing compound dispersed in an orally acceptable anhydrous hydrophobic pressure sensitive adhesive which composition when applied topically to tooth surfaces forms an adherent layer containing the peroxide compound which peroxide compound is thereafter released from the layer to effect tooth whitening.

2. The composition of claim 1 wherein the peroxide compound is sodium percarbonate.

3. The composition of claim 2 wherein the sodium percarbonate is present in the composition from about 0.5 to about 50 weight.%.

4. The composition of claim 1 wherein the peroxide compound is PVP/H₂O₂.

5. The composition of claim 4 wherein the concentration of PVP/H₂O₂ present in the composition is from about 0.5 weight % to about 50 weight %.

6. The composition of claim 1 wherein the anhydrous hydrophobic pressure sensitive adhesive is a silicone based pressure sensitive adhesive.

7. The composition of claim 6 wherein the silicone based pressure sensitive adhesive is a copolymer polymer prepared by condensing a silicone resin with a polydiorganosiloxane.

8. The composition of claim 6 wherein the silicone resin is a silanol-containing silicone resin.

9. The composition of claim 6 wherein the polydiorganosiloxane is polydimethyl siloxane.

10. The composition of claim 1 wherein the composition contains an adhesion enhancing agent.

11. The composition of claim 1 wherein the adhesion enhancer is a polyethylene gelled mineral oil.

12. The composition of claim 10 wherein the adhesion enhancing agent is petrolatum.

13. The composition of claim 1 wherein the pressure sensitive adhesive is present in the composition in an amount from about 40 to about 80 weight %.

14. A method for whitening teeth which comprises
(a) preparing a nonaqueous liquid tooth whitening composition of claim 1;
(b) painting the composition into contact with the teeth to be whitened;
(c) maintaining the composition in contact with the teeth for plurality of minutes per day; and
then,
(d) repeating steps b and c for multiple days to thereby whiten the teeth.
